(19) United States
(12) Patent Application Publication
(10) Pub. No.: US 2019/0032558 A1
(43) Pub. Date: Jan. 31, 2019

(54) AIR GUIDING DEVICE IN AN AIRCRAFT ENGINE

(71) Applicant: Rolls-Royce Deutschland Ltd & Co KG, Blankenfelde-Mahlow (DE)

(72) Inventor: Matthijs VAN DER WOUDE, Rangsdorf (DE)

(21) Appl. No.: 16/026,295

(22) Filed: Jul. 3, 2018

(30) Foreign Application Priority Data
Jul. 31, 2017 (DE) 10 2017 117 291.2

(51) Int. Cl. F02C 7/18; F02C 9/18

(52) U.S. Cl. CPC F02C 7/18; F05D 2220/323; F05D 2260/232; F02C 9/18

(57) ABSTRACT

An air-guiding device in an aircraft engine for air which has been heated by a core engine wall which surrounds a core engine, characterized by at least one air barrier device for preventing an air flow in an axially forward direction in the space around the core engine and for forming an air channel which extends, at least over a part, in the space around the core engine, wherein the air barrier device and the air channel extend radially from the core engine wall only over a part of the space that surrounds the core engine, and at least one air line to at least one outlet opening which opens into a region which exhibits a locally lower pressure than the pressure in the region of a cooling-air gap at the core engine wall, wherein the at least one outlet opening of the at least one air line opens directly into the bypass flow channel.

This application claims priority to German Application No. 10 2017 117 291.2 filed Jul. 31, 2017, which application is incorporated by reference herein.

The invention relates to an air-guiding device in an aircraft engine having the features of claim 1.

In aircraft engines, there are regions in which heated air must be discharged. A typical example of this is a core engine wall, which is cooled from the outside in order to adjust a gap between rotor blades of the aircraft engine and the inner side of the core engine wall, that is to say in order to keep the gap as constant and small as possible. Air-guiding devices in this context are known for example from US 2015/0260101 A1 or EP 2 224 009 A2.

It is the object to make the air guidance, in particular of the air heated at the core engine wall, efficient.

The object is achieved by means of an air-guiding device having the features of claim 1.

Here, at least one air barrier device serves for preventing an air flow in an axially forward direction in the space around the core engine. The air barrier device furthermore serves for forming an air channel which extends, at least over a part, in the space around the core engine. In this air channel, it is for example the case that the cooling air heated at the outer side of the core engine wall is collected and subsequently discharged. Here, the air barrier device and the air channel extend radially from the core engine wall not over the entire circumference of the core engine, that is to say they extend only over a part of the space that surrounds the core engine. With the resulting relatively small cross section of the air channel and the pressure gradient between static pressure at the bypass flow duct wall and the total pressure of the flow in the bypass flow duct, a correspondingly high flow speed is locally realized in the air channel.

In one embodiment, for the discharge of the heated air, at least one air line is used which guides the air to at least one outlet opening which opens out in a region which has a locally lower pressure than the pressure in the region of a cooling-air gap at the core engine wall. Owing to the pressure gradient, the air flows without an external supply of energy. Here, the at least one outlet opening of the at least one air line opens directly into the bypass flow channel, that is to say said outlet opening is not led through the aerodynamic fairing. Greater freedom with regard to the selection of the location for the outlet opening is thus realized.

In one embodiment, the at least one air channel is formed as a ring-shaped channel. This means that the heated air is guided in ring-shaped fashion around the core engine, wherein it is not imperative for the cross section of the air channel to be constant. Rather, the cross section of the air channel may adapt to the structural conditions in the aircraft engine. In this context, ring-shaped may also mean that the air channel extends over the entire circumference of the core engine.

To minimize turbulence, or for targeted control of the air, it is possible in a further embodiment for the at least one outlet opening of the air line to be coupled to at least one directing device, in particular a directing plate and/or a nozzle.

In a further embodiment, the at least one air line runs at least partially through the aerodynamic fairing between the core engine and the bypass flow channel. Such aerodynamic fairings commonly cover cables and/or lines which are guided through a region traversed by flow—for example the bypass flow channel. Here, it is for example possible for the at least one outlet opening to be arranged laterally on the aerodynamic fairing, in particular at the point with the greatest width of the aerodynamic fairing. In this way, the local pressure drop would be utilized for conveying the heated exit air in a particularly efficient manner.

It is also possible for the at least one outlet opening of the at least one air line to open directly into a surroundings space of the aircraft engine. The aerodynamic path length of the at least one air line is thus reduced, which permits a smaller air resistance and an effectively greater mass flow in the case of the same pressure gradient. In the case of multiple radially outwardly leading air lines, the cooling air that arises can be discharged in an even more effective manner.

It is furthermore also possible for the at least one outlet opening of the at least one air line to open into the region outside the outlet nozzle in the flow direction of the aircraft engine. It is also possible for the at least one outlet opening of the at least one air line to open into the region of the outlet surface of the aerodynamic fairing of the aircraft engine, or slightly beyond this. Thus, the emerging air would make a minimal contribution to the thrust of the aircraft engine, and the loss of the tapped air, compressed by the fan, in the bypass flow channel would be at least partially reduced.

For flexible adjustment of the cooling, it is possible, in one embodiment, for at least two air lines to discharge heated cooling air from different regions of the core engine wall.

The air flow rate in the at least one air line can be adjusted by means of a controllable valve. Here, in one implementable embodiment, the controllable valve, a valve controller and/or an actuating element may be arranged in the region of a sale of the aircraft engine, because relatively low temperatures prevail there in relation to the core engine wall.

It is thus basically possible, by means of the controllable valve, for the discharge of cooling air from the core engine wall to be controlled in open-loop or closed-loop fashion in order to adjust the size of a gap between rotors and the core engine wall.

In a further embodiment, the at least one air barrier device is formed from individual segments, because these can be assembled in an efficient manner.

The invention will be discussed in conjunction with the exemplary embodiments illustrated in the figures, in which:

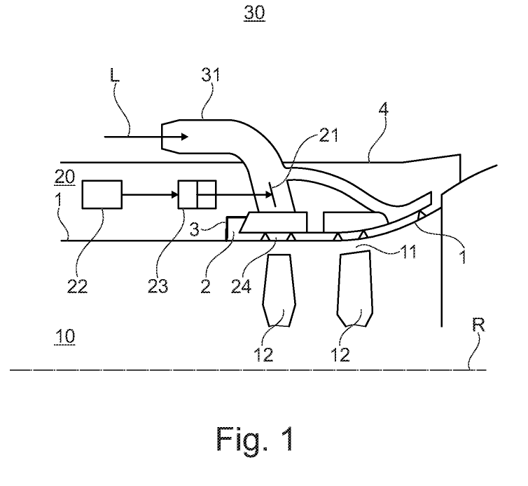

FIG. 1 shows a schematic axial sectional view of an embodiment of an air-guiding device;

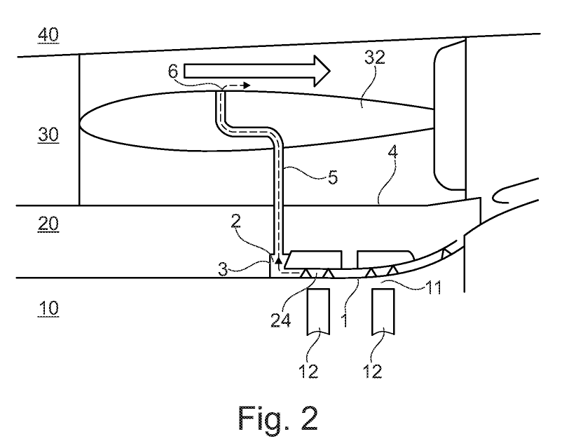

FIG. 2 shows a schematic axial sectional view of an embodiment of an air-guiding device with an air line to a bypass flow channel;

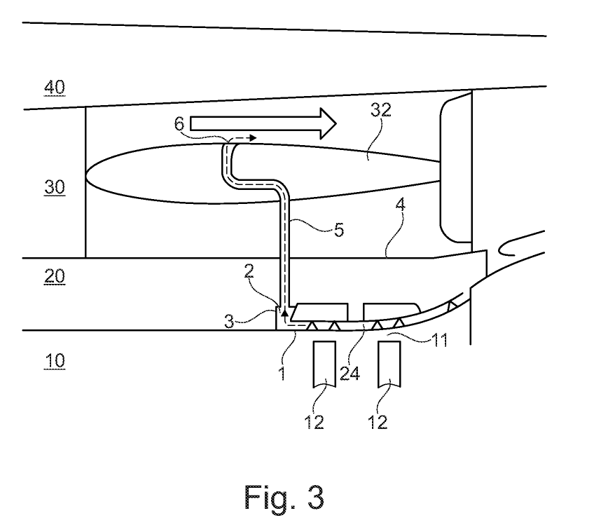

FIG. 3 shows a schematic axial sectional view of an embodiment of an air-guiding device with an air line to a bypass flow channel, wherein the outlet opening of the air line is inclined in a flow direction;

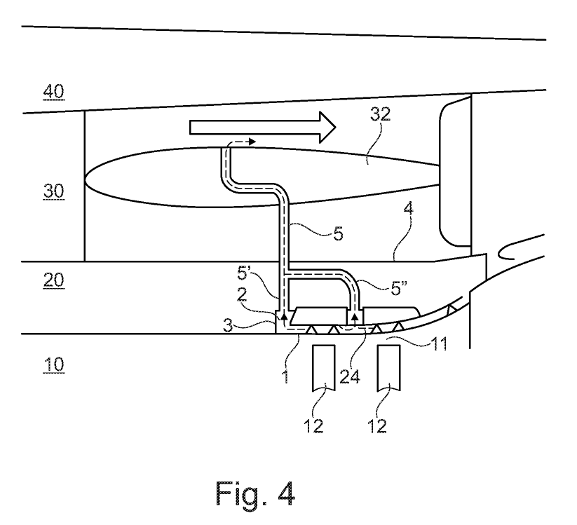

FIG. 4 shows a schematic axial sectional view of an embodiment of an air-guiding device with an air line (with two feed lines) to a bypass flow channel;

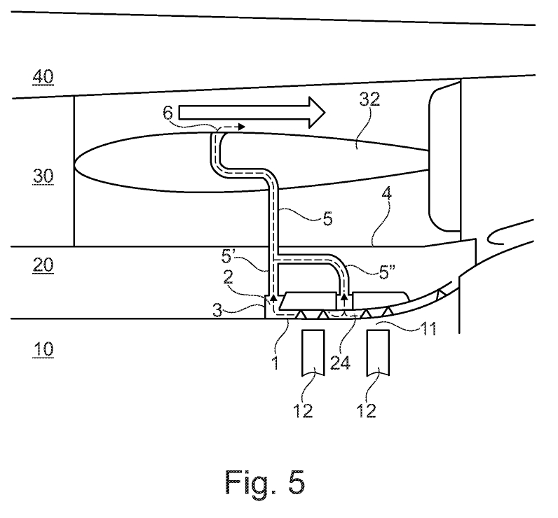

FIG. 5 shows a schematic axial sectional view of an embodiment of an air-guiding device with an air line (with two feed lines) to a bypass flow channel, wherein the outlet opening of the air line is inclined in a flow direction;

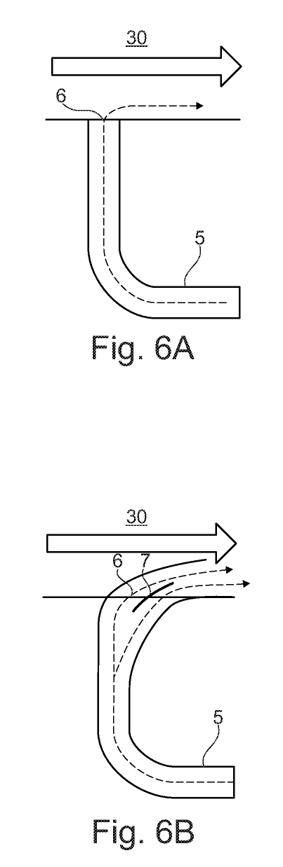

FIG. 6A shows a schematic sectional view of an outlet opening of an air line;

FIG. 6B shows a schematic sectional view of an outlet opening of an air line with a directing device;

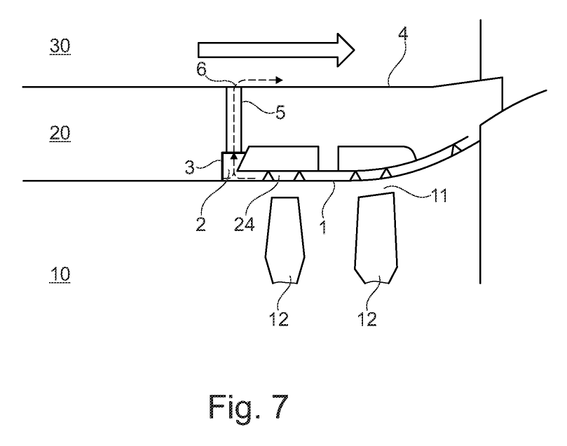

FIG. 7 shows a schematic sectional view of a further embodiment of an air-guiding device with a direct introduction of the air into the bypass flow channel;

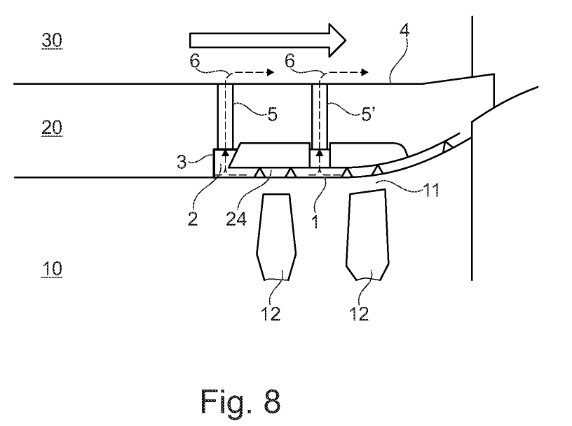

FIG. 8 shows a schematic sectional view of a further embodiment of an air-guiding device with a direct introduction of the air into the bypass flow channel via two air lines;

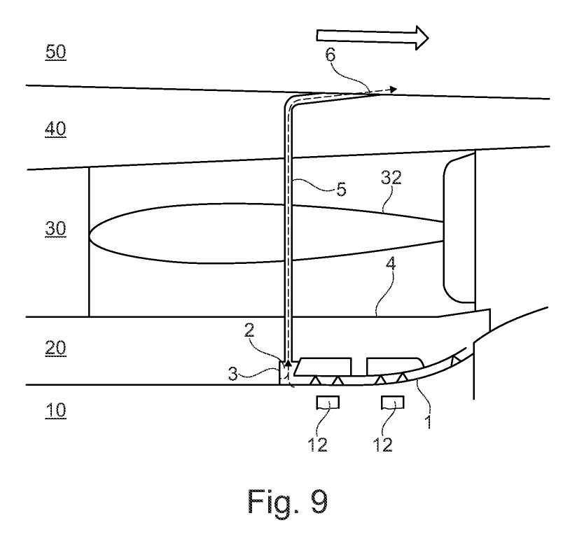

FIG. 9 shows a schematic sectional view of a further embodiment of an air-guiding device with an introduction of the air into a surroundings region of a nacelle of the aircraft engine;

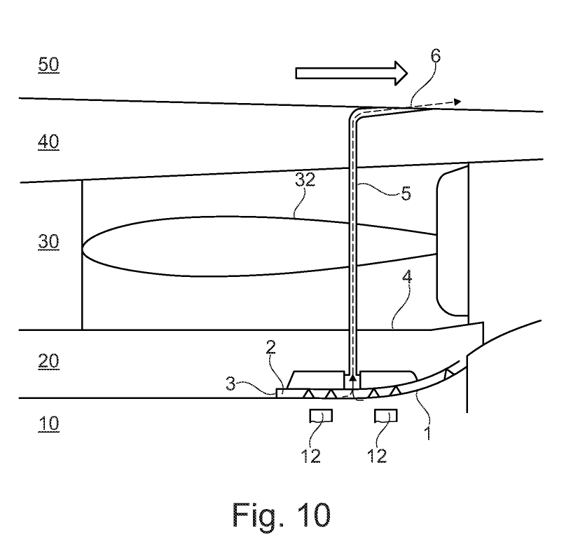

FIG. 10 shows a schematic sectional view of a further embodiment of an air-guiding device with an introduction of the air into the surroundings region of the nacelle of the aircraft engine with an air supply situated axially at the rear;

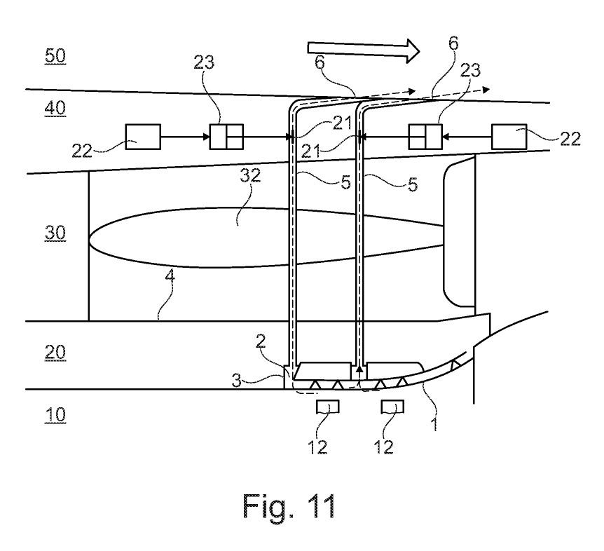

FIG. 11 shows a schematic sectional view of a further embodiment of an air-guiding device with an introduction of the air into the surroundings region of the nacelle of the aircraft engine with two feed lines with valve controllers;

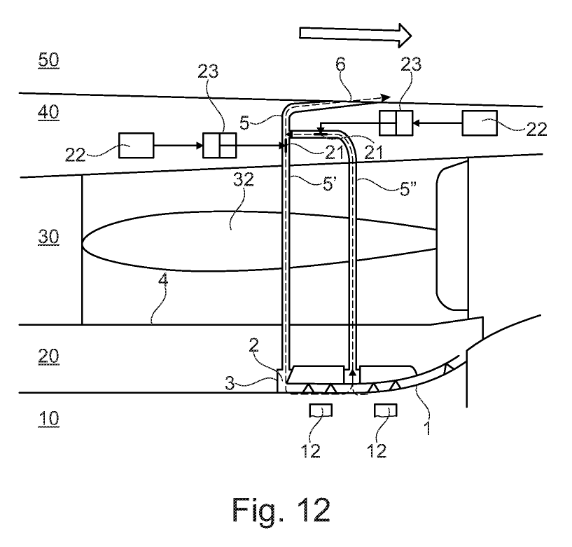

FIG. 12 shows a schematic sectional view of a further embodiment of an air-guiding device with an introduction of the air into the surroundings region of the nacelle of the aircraft engine with two merged air lines with valve controllers;

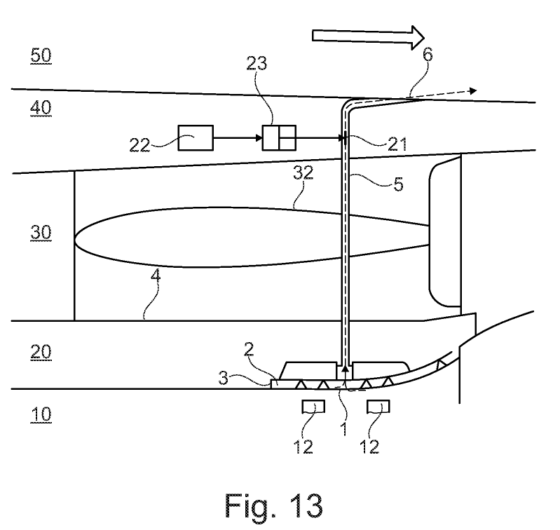

FIG. 13 shows a schematic sectional view of a further embodiment of an air-guiding device with an introduction of the air into the surroundings region of the nacelle of the aircraft engine with an air line for discharging heated air from an axially rear region with a valve controller;

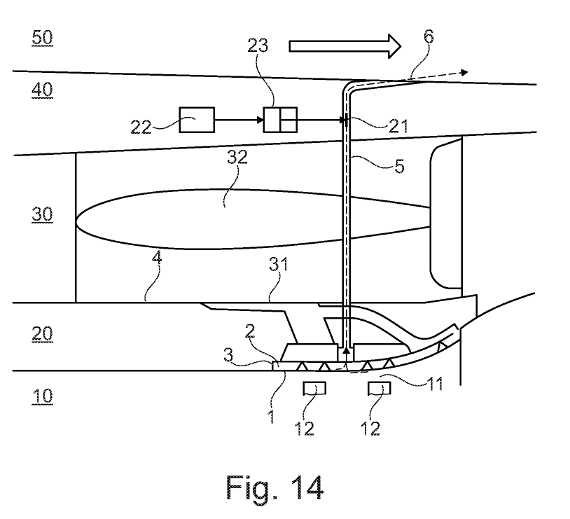

FIG. 14 shows a schematic sectional view of a further embodiment of an air-guiding device with an introduction of the air into the surroundings region of the nacelle of the aircraft engine with an air line for discharging heated air from an axially rear region with a valve controller and with a NACA air inlet in the bypass flow channel;

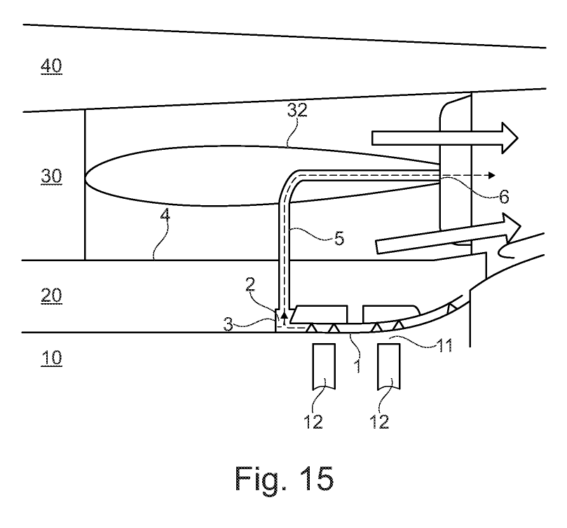

FIG. 15 shows a schematic sectional view of a further embodiment of an air-guiding device with an outlet opening for heated air at the outlet surface of the aerodynamic fairing (splitter fairing) of the aircraft engine;

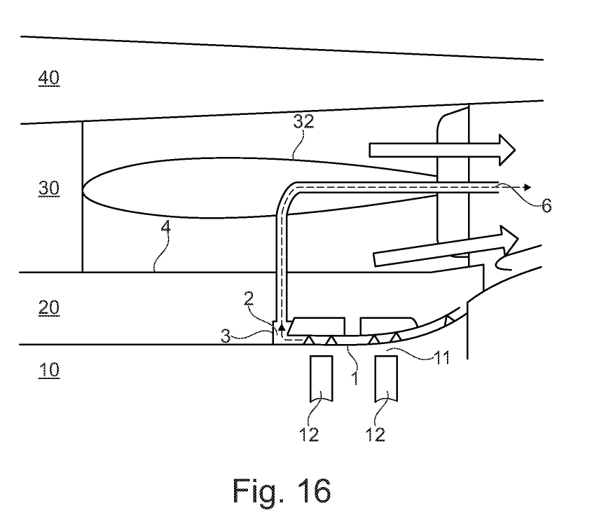

FIG. 16 shows a schematic sectional view of a further embodiment of an air-guiding device with an outlet opening for heated air slightly downstream of the outer surface of the aerodynamic fairing (splitter fairing) of the aircraft engine;

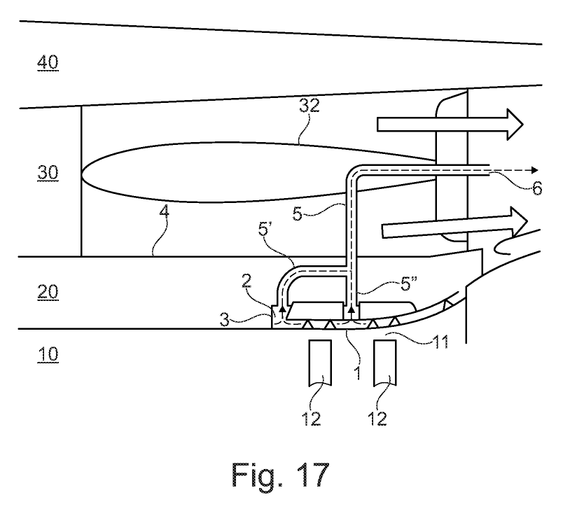

FIG. 17 shows a schematic sectional view of a further embodiment of an air-guiding device with two partial lines for taking in heated air, with an outlet opening for heated air at the outlet surface of the aerodynamic fairing (splitter fairing) of the aircraft engine;

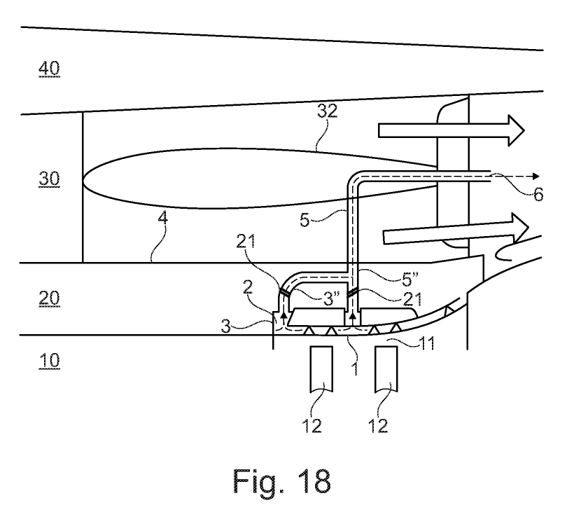

FIG. 18 shows a schematic sectional view of a further embodiment of an air-guiding device with two partial lines for taking in heated air, with an outlet opening for heated air at the outlet surface of the aerodynamic fairing (splitter fairing) of the aircraft engine and controllable valves.

FIG. 1 schematically illustrates a part of an aircraft engine such as is known per se. For clarity, only two rotor blades 12 of a turbine in the core engine 10 are illustrated here. The rotor blades 12 rotate about the axis of rotation R.

The generation of thrust in the aircraft engine is realized firstly by means of a hot-gas jet of the core engine 10 (primary circuit) and secondly by means of a second, called-air jet which is guided—in the bypass—past the core engine (secondary circuit) and which runs in the bypass flow channel 30. In the case of civilian bypass engines, the secondary circuit is responsible for the major part of the thrust. Between the core engine 10 and the bypass flow channel 30, there is arranged a space 20 which surrounds the core engine 10. In this space there are arranged, inter alia, air-guiding means such as a cooling-air gap 24, which means serve inter alia for cooling a core engine wall 1.

A gap 11 is situated between the tips of the rotor blades 12 and the core engine wall 1. The size of the gap 11 is, in a manner known per se, controlled in open-loop or closed-loop fashion by means of a supply of cooling air L in the region of the core engine wall 1 (active tip clearance control).

Here, in the illustrated embodiment, the cooling air L is extracted from the bypass flow channel 30 through an air inlet 31. In the embodiment as per FIG. 1, the air inlet 31 is formed as a nozzle which projects into the bypass flow channel. In alternative embodiments (see for example FIG. 14), use may for example also be made of a NACA inlet.

The air L is guided radially inward in the direction of the core engine wall 1 that is to be cooled. Here, the air flow rate is controlled by means of a valve 21. The position of the valve 21—and thus the air flow into the interior of the at least one cooling-air-distributing ring-shaped channel arranged around the core engine—is adjusted by means of an actuating element, in this case a motor 23. The actuating element 23 receives its control commands from a valve controller 22. In alternative embodiments, use may also be made of other forms of valves or actuating devices.

The cooling air subsequently passes into a cooling-air gap 24, which at least partially surrounds the core engine wall 1. By convective air cooling of the core engine wall 1, the size of the gap 11 can be adjusted.

Below, a description will be given of embodiments of air-guiding devices by means of which the air heated in the cooling-air gap 24 can be discharged in an efficient manner.

In the embodiment of an air-guiding device illustrated in FIG. 1, an air channel 2 which extends, at least over a part, in the space 20 around the core engine 10 serves for collecting the heated cooling air. Said air channel 2 may be formed as a ring-shaped channel, that is to say may extend around the core engine 10. Said air channel 2 serves for taking in and discharging air that has been heated at the core engine wall 1.

In the illustrated embodiment, the air channel 2 is formed, on one side, by an air barrier device 3 for preventing an air flow in an axially forward direction in the space 20 around the core engine 10, wherein the air barrier device 3 extends radially from the core engine wall 1 only over a part of the space 20 that surrounds the core engine 10. In this way, the space for the heated air is reduced in size in targeted fashion, because the air barrier device 3, and thus the ring-shaped channel 2, extend radially specifically not over the entire height of the space 20 around the core engine 10. The smaller volume inevitably leads to a higher flow speed of the heated air as it flows out. By means of the air barrier device 3, a fluidic and thermal separation of the space 20 from the air channel 2 and from the space situated downstream thereof—as viewed in the main flow direction—is achieved.

The air barrier device 3 may be formed, along the circumference of the aircraft engine, from individual segments, which facilitates the assembly process.

In the embodiment illustrated, the air channel 2 and the air barrier device 3 are produced from metal. For clarity, only one air channel 2 is illustrated in FIG. 1. In other embodiments, the geometry of the cross section and/or the spatial orientation of the air channel 2 and/or of the air barrier device 3 may be configured differently.

FIG. 2 illustrates a further embodiment of an air-guiding device, wherein the basic arrangement in the region of the space 20 around the core engine 10 corresponds to the embodiment as per FIG. 1, such that reference can be made to the corresponding description.

In the embodiment as per FIG. 2, in the bypass flow channel 30, there is arranged an aerodynamic fairing 32 which leads radially from the inside toward the outside and the cross section of which is, in the illustration of FIG. 2, shown rotated through 90°. This aerodynamic fairing 32, which is known per se from the prior art, serves for the streamlined coverage of connections and lines between the core engine 10 and a nacelle 40 that surrounds the aircraft engine at the outside. The air flow in the bypass flow channel 30 is indicated in FIG. 2 (and in the following figures) by a large arrow.

The region that is delimited by the air barrier device 3 has an air line 5 to the bypass flow channel 30. Here, the air line 5 runs entirely or partially through the aerodynamic fairing 32. Here, the heated air exits into the bypass flow channel 30 via an outlet opening 6 on the side of the aerodynamic fairing 32. Here, the outlet opening 6 may in particular be arranged at the point of the greatest width of the aerodynamic fairing. At this point, the local flow speed in the bypass flow channel 30 is at its highest, and thus the local static pressure is at its lowest. It is however basically also possible for the outlet opening to be arranged at some other point of the aerodynamic fairing 32, preferably downstream of the stated point, because there, the influence of the outflowing cooling air has a lesser influence on the bypass flow and thus disrupts the latter to a lesser extent. Even if the local static pressure is somewhat higher there, it is still lower than in the cooling-air gap 24 around the core engine wall 1, which is sufficient as a driving pressure gradient of the cooling air.

In the illustrated embodiment, the outflowing airstream is, in a simple embodiment, substantially orthogonal to the flow through the bypass flow channel 30. This is illustrated in detail in FIG. 6A. The region of the outlet opening 6 is situated in this case in a region with a static pressure lower than in the cooling-air gap 24 at the core engine 10, such that the heated cooling air can flow out under the influence of the pressure gradient.

The region of the lower static pressure may be situated for example in the region of the bypass flow channel 30 (see FIGS. 2 to 8), in the surroundings region 50 of the nacelle 40 of the aircraft engine (see FIGS. 9 to 14) and/or in the outlet region of the aerodynamic fairing 32 (see FIGS. 15 to 18).

The static air pressure for example in the bypass flow channel 30 is basically lower than the static pressure in the interior of the cooling-air gap, such that the air flow can be discharged without a supply of external energy. The air flow in the bypass flow channel 30 may also serve for locally generating a negative pressure at the outlet opening 6 (Bernoulli effect), such that the hot air can be drawn into the bypass flow channel 30 more quickly. Here, however, the driving pressure gradient of the tapping of the cooling-air flow is in fact to be regarded as a total pressure with a kinetic component in relation to the static pressure orthogonal to the bypass flow.

FIG. 3 illustrates a variation of the embodiment of FIG. 2, such that reference can be made to the corresponding description.

Here, the outlet opening 6 of the air line 5 is inclined in the direction of the air flow in the bypass flow channel 32. This possible variation of the simplest solution shown in FIG. 6A is illustrated in FIG. 6B. This embodiment results in a reduced adverse influence on the flow efficiency of the bypass flow.

FIG. 4 illustrates a modification of the embodiment as per FIG. 2. In addition to the air line 5 of the embodiment as per FIG. 2, the air line 5 has two partial lines 5′, 5″ which guide heated air from different parts of the cooling-air gap 24 into the bypass flow channel 32. A first partial line 5′ guides heated air from the region of the air barrier device 3 into the air line 5. A second partial line 5″ guides heated air from a part of the cooling-air gap 24 situated axially further to the rear into the air line 5.

The outlet opening 6 of the air line into the bypass flow channel 32 is in this case arranged substantially at right angles to the flow in the bypass flow channel 30, as is also illustrated in FIG. 6A.

The embodiment as per FIG. 5 varies this solution by virtue of the outlet opening 6—as in the embodiment as per FIG. 3—being inclined in the direction of the air flow in the bypass flow channel 30, as illustrated in FIG. 6B.

FIGS. 6A and 6B illustrate outlet openings of the air line 5 into the bypass flow channel 30 in detail.

FIG. 6A illustrates the situation in which the heated air flows in substantially perpendicular to the flow in the bypass flow channel 30.

In the embodiment as per FIG. 6B, the outlet opening 6 is oriented in the direction of the flow in the bypass flow channel 30, wherein, here, a directing device 7 is additionally arranged in the outlet opening 6, which directing device guides the outflowing air into the flow of the bypass flow channel 30. In this way, undesired turbulence can be reduced. In alternative embodiments, the guide device 7 may also have the form of an axially rearwardly directed nozzle.

FIG. 7 illustrates a further embodiment of an air-guiding device. By contrast to, for example, the embodiment as per FIG. 2, the heated air is in this case guided directly into the bypass flow channel 30 through, for example, the at least one air line 5 which leads radially outward to the core engine fairing 4 (fairing), and not through the aerodynamic fairing 32. The basic principle of the air guidance from the core engine wall 1 to the bypass flow channel 30 is however analogous to the embodiments of FIGS. 2 to 5. Here, too, a local static pressure prevails which is lower than in the cooling-air gap 24 around the core engine wall 1. The lowest static pressure prevails in the region in which the flow speed is at its highest, and the line 5 can be led to that point.

Furthermore, the outlet opening may be designed either as illustrated in FIG. 6A or as illustrated in FIG. 6B, which also applies to the following FIG. 8.

FIG. 8 illustrates a modification of the embodiment as per FIG. 7. Instead of a single air line 5, use is made in this case of two air lines 5 guiding air heated by the core engine wall 1 directly into the bypass flow channel 30. Here, the first air line 5 guides air from the region of the air barrier device 3, and the second air line 5, situated axially further to the rear, guides heated air from a correspondingly rear region of the aircraft engine, into the bypass flow channel 30.

FIG. 9 illustrates a further embodiment of the air-guiding device, wherein the air guidance in the region of the core engine wall 1 is analogous to that in the embodiments already discussed, wherein the heated air is guided into the air line 5 in the region of the air barrier device 3 situated axially toward the front.

As in the embodiments of FIGS. 2 to 5, it is also the case here that the air line 5 passes through an aerodynamic fairing 32, wherein it is however the case here that the outlet opening 6 of the air line 5 is arranged at the outer side of the nacelle 40, that is to say is directed into the surroundings space 50 (free flow around the aircraft engine) of the nacelle 40. Here, the outlet opening 6 is directed rearward, that is to say substantially in the direction of the air flow (arrow) in the surroundings space 50. Turbulence is thus reduced. Here, it is accepted that the discharged air is extracted from the bypass flow of the engine, and is ultimately lost with regard to the propulsion, wherein, however, the negative pressure in the surroundings space 50 during the operation of the aircraft engine is particularly high.

FIG. 10 illustrates a modification of the embodiment of the air-guiding device as per FIG. 9, wherein, here, the heated cooling air is discharged into the surroundings region 50 of the nacelle 40 from a point axially further toward the rear in the aircraft engine. This suction point may also be implemented in the preceding embodiments, in the case of which the front air lines 5 in the ring-shaped channel 2 could alternatively be omitted.

FIG. 11 illustrates a further modification of the embodiments of the air-guiding devices as per FIGS. 9 and 10, that is to say the heated cooling air is guided into the surroundings region 50 of the nacelle 40. By contrast to the other embodiments, it is the case in this embodiment the two separate air lines 5 are used, which take in the heated cooling air at two points: in one case at the front in the region of the air barrier device 3, and in one case in a region situated axially further to the rear. Furthermore, this embodiment also includes valves 21 in the air lines 5, which valves are actuated by valve controllers 22 and actuating elements 23 (motors). The valves 21, the valve controller 22 and the actuating elements 23 are in this case arranged in the relatively cool region of the nacelle 40, and could be selected instead of the valve 21 situated in the hot region in FIG. 1, such that the cooling-air flow would be controlled in closed-loop fashion at the outlet, and the cooling-air supply lines would be permanently charged with the total pressure.

It is also possible for only one of the cooling lines 5 to be equipped with a controllable valve 21. In any case, it is thus possible to implement flexible open-loop or closed-loop control of the gap 11 between the rotor blades 12 and the core engine wall 1.

FIG. 12 shows a further variation of the embodiments of the air-guiding devices as per FIGS. 9, 10 and 11. As in the embodiment as per FIG. 11, the heated cooling air is in this case discharged from two regions of the cooling-air gaps 24 at the core engine wall 1 through partial air lines 5′, 5″. The partial air lines 5′, 5″ are merged in the region of the nacelle 40, such that only one air line 5 guides the heated cooling air to the outlet opening 6 such that the air is ultimately discharged into the surroundings region 50 of the nacelle 40.

Controllable valves 21 are arranged in each of the two partial air lines 5′, 5″. As in the embodiment as per FIG. 11, it is thus possible for different flow rates of heated cooling air to be extracted from the individual regions of the core engine walls 1, in order to realize different and targeted cooling of different regions of the core engine wall 1.

FIG. 13 illustrates a variation of the embodiment as per FIG. 10, wherein, here, the heated cooling air is taken in only in the axially rear part of the cooling-air gap 24 and guided into the surroundings region 50 of the nacelle 40. Here, the air flow rate in the air line 5 is controllable by means of a valve 21.

FIG. 14 illustrates a further modification of the embodiment as per FIG. 13 and FIG. 1. Here, a NACA scoop is provided as an air inlet 13 in order to bring the cooling air into the interior of the cooling-air distributing rings to the core engine wall 1. The cooling air heated at the core engine wall 1 is then collected and taken in again in the axially rear region of the core engine wall 1, and directed via the air line 5 into the surroundings region 50 of the nacelle 40. The cooling air is controllable by means of a valve 21.

FIGS. 15 to 17 illustrate embodiments of the air-guiding device in which the outlet opening 6 of an air line 5 is arranged at the rear end of the aerodynamic fairing 32. The heated cold air thus flows coaxially into a wake area of the aerodynamic fairing 32 with the flow in the bypass flow channel 30. Additional flow losses are thus minimized. By virtue of the suctioned air being recirculated back into the bypass flow channel, the total mass flow balance remains the same, and a small contribution to the thrust of the aircraft engine is also made, or the initially compressed air is not extracted from the cyclic process, as is the case in the embodiments of FIGS. 9 to 14.

In the embodiment as per FIG. 16, the heated cooling air in the region of the air barrier device 3 is discharged through the air line 5 at a point slightly downstream of the outlet surface of the aerodynamic fairing 32, where the static pressure is somewhat lower than at the outlet surface.

FIG. 15 shows the embodiment in which the heated cooling air in the region of the air barrier device 3 is discharged through the air line 5 into the outlet surface of the aerodynamic fairing 32, wherein the static pressure is somewhat higher than downstream of the outlet surface. In the embodiments as per FIGS. 16 to 18, the outlet openings 6 are arranged further rearward, such that somewhat more effective suction is possible.

In the embodiment as per FIG. 17, two partial lines 5′, 5″ merge to form an air line 5. Said partial lines may however also be formed individually and led to different points of the outer surface of the aerodynamic fairing 32, or slightly downstream thereof, in a manner which is not illustrated.

In the embodiments as per FIGS. 15 to 17, the air lines 5 (and also the partial lines 5′, 5″) are each illustrated without valves 21. It is basically also possible, for example, for the partial lines 5′, 5″ to be equipped with controllable valves 21, as is illustrated by way of example for the embodiment of FIG. 18. For clarity, the valve controllers 22 and motors 23 are not illustrated here.

It is pointed out that, in alternative embodiments, different guidance configurations of the air channels 5 and of the outlet openings 6 thereof may be combined with one another. For example, it is possible for one air channel 5 to end in the bypass flow channel 30, and for a further air channel 5 to end in the region of the outlet surface of the aerodynamic fairing 32.

### LIST OF REFERENCE DESIGNATIONS

1 Core engine wall
2 Air channel
3 Air barrier device
4 Core engine fairing
5 Air line
5′, 5″ Partial lines of the air line
6 Outlet opening of the air line
7 Directing device
10 Core engine
11 Gap
12 Rotor blades
20 Space surrounding the core engine
21 Valve
22 Valve controller
23 Actuating element (motor)
24 Cooling-air gap
30 Bypass flow channel
31 Air inlet
32 Aerodynamic fairings
40 Nacelle
50 Surroundings region of the nacelle
L Air (cooling air tapped from bypass flow)
R Axis of rotation

1. An air-guiding device in an aircraft engine for air which has been heated by a core engine wall which surrounds a core engine,
characterized by
at least one air barrier device for preventing an air flow in an axially forward direction in the space around the core engine and for forming an air channel which extends, at least over a part, in the space around the core engine, wherein the air barrier device and the air channel extend radially from the core engine wall only over a part of the space that surrounds the core engine.

2. The air-guiding device according to claim 1, wherein the at least one air channel is formed as a ring-shaped channel.

3. The air-guiding device according to claim 1, wherein at least one air line to at least one outlet opening which opens into a region which exhibits a locally lower pressure than the pressure in the region of a cooling-air gap at the core engine wall.

4. The air-guiding device according to claim 3, wherein the at least one outlet opening of the at least one air line is coupled to at least one directing device, in particular at least one directing plate and/or a nozzle.

5. The air-guiding device according to claim 3, wherein the at least one air line runs at least partially through an aerodynamic fairing between the core engine and the bypass flow channel.

6. The air-guiding device according to claim 5, wherein the at least outlet opening is arranged laterally on the aerodynamic fairing, in particular at the point with the greatest width of the aerodynamic fairing, or further downstream.

7. The air-guiding device according to claim 3, wherein the at least one outlet opening of the at least one air line opens directly into the bypass flow channel.

8. The air-guiding device according to claim 3, wherein the at least one outlet opening of the at least one air line opens directly into a surroundings space of the aircraft engine.

9. The air-guiding device according to claim 3, wherein the at least one outlet opening of the at least one air line opens into the region outside the outlet nozzle in the flow direction of the aircraft engine, or the at least one outlet opening of the at least one air line opens into the region of the outlet surface of the aerodynamic fairing of the aircraft engine, or slightly beyond this.

10. The air-guiding device according to claim 1, wherein, by means of at least two air lines, heated cooling air can be discharged from different regions of the core engine wall.

11. The air-guiding device according to claim 1, wherein at least one controllable valve is arranged in the at least one air line.

12. The air-guiding device according to claim 11, wherein the controllable valve, a valve controller and/or an actuating element are arranged in the region of a nacelle of the aircraft engine.

13. The air-guiding device according to claim 11, wherein, by means of the controllable valve, the discharge of cooling air from the core engine wall can be controlled in open-loop or closed-loop fashion in order to adjust the size of a gap between rotors and the core engine wall.

14. The air-guiding device according to claim 1, wherein the at least one air barrier device is formed from individual segments.
